(19) United States
(12) Patent Application Publication
(10) Pub. No.: US 2014/0066287 A1
(43) Pub. Date: Mar. 6, 2014

(54) Low Cost Manufacture of High Reflectivity Aluminum Nitride Substrates

(71) Applicant: CMC Laboratories, Inc., Tempe, AZ (US)

(72) Inventors: Jonathan H. HARRIS, Scottsdale, AZ (US); Thomas NEMECEK, Tempe, AZ (US); Robert TESCH, Phoenix, AZ (US)

(21) Appl. No.: 13/798,368

(22) Filed: Mar. 13, 2013

Related U.S. Application Data
(60) Provisional application No. 61/695,848, filed on Aug. 31, 2012.

(51) Int. Cl. C04B 35/581

(52) U.S. Cl. CPC C04B 35/581
USPC 501/152; 423/412; 264/650

(57) ABSTRACT

A sintered aluminum nitride substrate having a thermal conductivity of about 60 W/m-K to about 150 W/m-K, a flexural strength of about 200 MPa to about 325 MPa, a volume resistivity of greater than 10¹⁰ Ohm cm, a density of at least about 95% of theoretical, optionally at least 97%, and a reflectance factor of at least about 60% substantially over the wavelength range of 360 nm to 820 nm. A low temperature process for sintering aluminum nitride includes providing an AlN sintering formulation of AlN powder and a sintering aid of yttria, calcia, and optionally added alumina, forming the AlN sintering formulation into a green body, and sintering the green body at a temperature of about 1675° C. to 1750° C.

The present application claims the benefit of the filing date of U.S. Provisional Application for Patent Ser. No. 61/695,848, filed Aug. 31, 2012, which application is incorporated by reference herein.

The present disclosure relates generally to the manufacture of aluminum nitride substrates useful for electronic packages. The disclosure also relates to the manufacture and use of aluminum nitride substrates for the electronic packaging of light emitting diodes, such as high brightness light emitting diodes.

A light-emitting diode (LED) is a semiconductor light source. The LED consists of a chip of semiconducting material doped with impurities to create a p-n junction. Current flows from the p-side, or anode, to the n-side, or cathode, but not in the reverse direction. Charge-carriers, electrons and holes, flow into the junction from electrodes with different voltages. When an electron meets a hole, it falls into a lower energy level, and releases energy in the form of a photon.

One advantage of LED-based lighting sources is high luminous efficacy. However, luminous efficacy decreases sharply with increasing current. This effect limits the light output of a given LED, raising heating more than light output for higher current. High-power LEDs are subjected to higher junction temperatures and higher current densities than traditional LEDs. This causes stress on the device and may cause early light-output degradation. If LED circuitry gets too hot, more current will pass through the junction. When too much current passes through the junction, it may cause irreversible burn-out of the device.

High power LEDs are mounted on a heat sink to allow for heat dissipation. These LEDs use large semiconductor dies to handle the large power inputs. Also, the semiconductor dies may be mounted onto metal slugs of aluminum or copper to allow for heat removal from the LED die.

For high brightness LEDs (HBLEDs), power needs are increasing rapidly, so that they require electronic packages with higher thermal performance to accomodate this higher power level. Current HBLED packages are made using aluminum oxide (alumina) ceramic dies. The dies are laser drilled to form vias and then metallized with thin film copper, and then thick-plated copper. The copper forms the pads on which to mount the LED, and also the electrical traces. A thin layer of nickel and gold may be plated on top of the copper to prevent oxidation.

The ceramic die with the accompanying metallization is referred to as a “tile”. In certain embodiments, the tile may be 4.5 inches by 4.5 inches by 0.020 inches in dimension. There may be 1000-4000 LEDs attached to one tile. After the LEDs are mounted on the tile, they are electrically connected to the copper pads, and then a lens material is molded over the LED units under pressure. Lastly, the individual LED units mounted on the ceramic may be singulated out using a saw or laser.

The thermal requirements for HBLEDs are surpassing the capabilities of alumina ceramic to provide adequate heat dissipation. Performance factors for an alternative die material include one or more of the following.

High thermal performance. The HBLEDs produce a lot of heat which must be removed to prevent overheating and performance degradation.

Low cost. As in all industries, the whole supply chain for HBLEDs is under pressure for cost reduction, as a main application for HBLEDs is general lighting. For LED lighting to be commercially successful, the price of the product to consumers must achieve a competitive level against conventional lighting products.

Good mechanical strength. The tile manufacturing process, including laser drilling, rack plating, and the LED assembly process, including molding the lens, puts a mechanical stress on the ceramic die material. If the ceramic is not strong enough, then the tile will break and will result in a yield loss, and thus is a further cost issue.

Electrical insulation. The material must be a reasonable electrical insulator so that the ceramic does not lead to a large leakage current between the positive (+) and negative (−) LED pads.

Light reflectivity or reflectance factor. Any LED light absorbed by the ceramic die or tile is a loss for the LED. The more reflective the ceramic, the better the light output of the device will be. This reflection can be direct reflection from the ceramic surface, or spectral reflection from the surface and the bulk of the ceramic.

A ceramic material that has adequate thermal performance, mechanical strength, and electrical insulation properties for HBLED products is aluminum nitride, particularly with respect to increased thermal demand as LED power increases. However, the cost of aluminum nitride (AlN) ceramic substrate manufacture (including raw material costs) as compared to that of alumina ceramic substrates has been an issue in the industry's moving from alumina to AlN ceramic dies. In addition, AlN also is either grey or brown and absorbs signficant amounts of visible light.

Provided is an aluminum nitride ceramic substrate material that provides the desired characteristics of high thermal performance, good mechanical strength, good electrical insulation, and high light reflectivity or reflectance factor at a low cost of manufacture.

Also provided is a low cost manufacturing process for producing aluminum nitride ceramic substrates having high thermal performance, good mechanical strength, good electrical insulation, and high light reflectivity or reflectance factor.

### BRIEF DESCRIPTION OF THE DRAWINGS

FIG. 1 is a scanning electron micrograph of a cross-section of an AlN body showing AlN grains wetted by a second phase.

FIG. 2 is a scanning electron micrograph of a cross-section of an AlN body showing AlN grains and a de-wetted second phase.

FIG. 3A is a scanning electron micrograph of a cross-section of the microstructure of a low temperature sintered AlN pressed pellet at a magnification of 300×.

FIG. 3B is a scanning electron micrograph of a cross-section of the microstructure of a portion of the low temperature sintered AlN pressed pellet shown in FIG. 3A at a magnification of 1000×.

FIG. 4A is a scanning electron micrograph of a cross-section of the microstructure of a low temperature sintered AlN pressed pellet at a magnification of 750×.

FIG. 4B is a scanning electron micrograph of a cross-section of the microstructure of a portion of the low temperature sintered AlN pressed pellet shown in FIG. 4A at a magnification of 3000×.

FIG. 5A is a scanning electron micrograph of a cross-section of the microstructure of a low temperature sintered AlN laminated tape at a magnification of 300×.

FIG. 5B is a scanning electron micrograph of a cross-section of the microstructure of a portion of the low temperature sintered AlN laminated tape shown in FIG. 5A at a magnification of 3000×.

FIG. 6A is a scanning electron micrograph of a cross-section of the microstructure of a low temperature sintered AlN laminated tape at a magnification of 750×.

FIG. 6B is a scanning electron micrograph of a cross-section of the microstructure of a portion of the low temperature sintered AlN laminated tape shown in FIG. 6A at a magnification of 1000×.

FIG. 7 is a graphical representation of Reflectance Factor as a function of wavelength of light for samples of sintered AlN.

FIG. 8 is a graphical representation of Reflectance Factor as a function of wavelength of light for samples of sintered AlN.

The AlN ceramic substrate that is provided is useful to the HBLED industry.

The present AlN ceramic substrates are manufactured from a formulation that sinters at lower temperature, therefore involving much lower furnace capital costs. Further, the present manufacturing process comprises the use of a low cost AlN powder in the low temperature sintering formulation.

The present low temperature sintered AlN ceramic substrates exhibit a thermal conductivity of about 60 W/m-K to 150 W/m-K, in certain embodiments, greater than about 90 W/m-K, and in other embodiments, greater than about 105 W/m-K. Although the present low temperature sintered AlN substrates exhibit a thermal conductivity that is lower than conventional high temperature sintered AlN substrates, which exhibit a thermal conductivity of about 170 W/m-K, the thermal conductivity of the present AlN ceramic substrate material at 60 W/m-K is 3 times higher than alumina, and at 90 W/m-K is 4.5 times higher than that of alumina. ‘These thermal conductivities represent a high thermal performance that is very acceptable for HBLED applications.

The present low temperature sintered AlN substrates exhibit a mechanical flexural strength of about 200 MPa to 325 MPa, in some embodiments about 250 MPa to about 325 MPa, and in other embodiments about 300 MPa to 325 MPa, which is substantially the same strength as the high temperature sintered AlN substrate material at 300 MPa to 350 MPa, and thus is very acceptable for HBLED applications. This is unexpected, as in the past, low temperature sintered AlN materials tended to exhibit a lower mechanical strength than high temperature sintered AlN material.

The present low temperature sintered AlN substrates exhibit electrical insulation properties, namely a volume resistivity of greater than 10¹⁰ Ohm cm, in certain embodiments about 10¹² to about 10¹⁴ Ohm cm, that is the same as standard high temperature sintered AlN, and similar to alumina substrates. These are therefore acceptable for HBLED applications.

The present low temperature sintered AlN substrates exhibit a white appearance, rather than the grey or tan appearance that is exhibited by conventional high temperature sintered AlN material. The present low temperature sintered AlN substrates may therefore be produced so as to be much more reflective of light than the high temperature sintered AlN ceramic substrate material, as discussed below. This is quite unexpected, because in the past, AlN sintered to high density was either grey or brown.

The present AlN sintering formulation comprises AlN powder and a sintering additive combination that provides the desired balance of properties in the low temperature sintered AlN ceramic substrate product. The sintering additive, or sintering aid, includes a very narrow range of composition in the Calcium, Yttrium, Aluminum Oxide (Ca—Y—Al—O) system that provides the desired properties. The sintering aid may be present in the sintering mixture in an amount of about 3 to about 10 weight percent by weight of the AlN powder, and in certain embodiments, about 4 to about 7 weight percent.

The sintering aid formulation may comprise a weight ratio of about 3-5 Yttria to about 0.5-1.5 Calcia, and to about 0-1 added Alumina.

In various embodiments, the sintering aid formulation may comprise a weight ratio of:
4 Yttria to 1 added Alumina and 1 Calcia;
4 Yttria to 0.8 added Alumina and 1 Calcia;
5 Yttria to 1 added Alumina and 1 Calcia; and
4 Yttria to I Calcia with no added Alumina.

According to the present low temperature sintering process, the second phase which results from the sintering reaction, contains no, or only small amounts of calcium containing compounds.

When calculating the amount of alumina available for sintering the AlN powder, it should be understood that different AlN powders may contain varying amounts of native alumina that may participate in the sintering reaction. Also, if a binder, used in forming an AlN article, is burned out in an oxygen containing-atmosphere, such as air, prior to sintering, different amounts of alumina may be formed in the article at different binder burnout temperatures.

As the sintering aid composition is shifted to include more yttria, the resulting sintered AlN material becomes electrically conducting and very weak mechanically. If the sintering aid composition is shifted to include more alumina, the thermal conductivity properties decrease.

In certain embodiments, the AlN sintering formulation is formed into a substrate green body precursor by tape casting. The AlN sintering formulation may therefore include conventional tape casting additives, such as an organic binder and optionally a dispersant, plasticizer and/or solvent. After the green AlN tape is cast, the binder may be removed by being burned out in air, such as for example at a temperature of about 600-750° C., in certain embodiments about 700° C., which may add a minor amount of alumina to the AlN, as discussed above.

The AlN powder used in the present AlN sintering formulation is that which is made by the direct nitridation of aluminum metal (produced generally for structural ceramic applications), rather than AlN powder made by the carbothermal reduction of alumina, commonly used in the manufacture of AlN substrates for RE (electronic) applications. The directly nitrided AlN powder is available in volume at a cost of 30% to 40% of the cost of carbothermally reduced AlN powder. However, directly nitrided AlN powder is generally more difficult to sinter. Surprisingly, AlN substrates produced from directly nitrided AlN powder according to the present low temperature sintering process are more highly reflective, that is, have a higher reflectance factor, than those substrates produced from carbothermally reduced AlN powder, and appear white rather than grey.

Among the differences between AlN powder produced by the carbothermal process and AlN powder produced by the direct nitridation process is the particle size distribution of the resulting powder. AlN powder produced by the carbothermal process characteristically has a narrow particle size distribution, while AlN powder produced by the direct nitridation process characteristically has a much wider particle size distribution.

In general, the powder size distribution for directly nitrided (DN) AlN powder may be on the order of:
d(10%)=0.3-0.6 microns with about 0.4 microns typical,
d(50%)=2.0-4.5 microns with 2.0 microns typical,
d(90%)=6-9.5 microns with 7.5 microns typical.

For carbothermally reduced (CR) AlN powder, the distribution may be much narrower, on the order of
d(10%)=about 0.5 microns,
d(50%)=about 1.1 microns,
d(90%) about 4-5 microns.

The present AlN sintering formulation is very effective in sintering the lower cost, directly nitrided, AlN powder. In one embodiment, a directly nitrided AlN powder was sintered using the present sintering aid formulation at about 1700° C., to produce an AlN substrate having 97% of theoretical density, while sintering the same AlN powder using the conventional yttria sintering additive at 1825° C., produced an AlN substrate having only 80% of theoretical density.

In certain embodiments, the aluminum nitride ceramic substrate fabrication process comprises a tape casting process in which a green body of the AlN substrate precursor is formed by being cast into a tape. The AlN sintering formulation, comprising the aluminum nitride powder and sintering aids (calcia, yttria, and optionally added aluminum oxide), as well as organic binder (such as polyvinylbutyral), dispersants, plasticisers and/or solvents, are mixed together to achieve a viscosity suitable for tape casting, similarly to conventional AlN tape casting. In another embodiment, the AlN sintering formulation may be processed in an aqueous slurry.

The green (pre-sintered) tape comprising the sintering formulation is cast (and optionally cut) into thin sheets, which may be laminated together in order to achieve a desired green body density. This optionally isotactic lamination process increases thickness of the green body, and improves the uniformity of the density of the green body.

Other green body forming processes, such as but not limited to spray drying with roll compaction and dry pressing of spray dried powder, may also be used.

The green body is then subjected to binder burnout, for example in a continuous furnace having an oxygen containing atmosphere, such as air, at a temperature of about 600-750° C.

The green body may be sectioned into tile or substrate precursors, prior to binder burnout or prior to sintering.

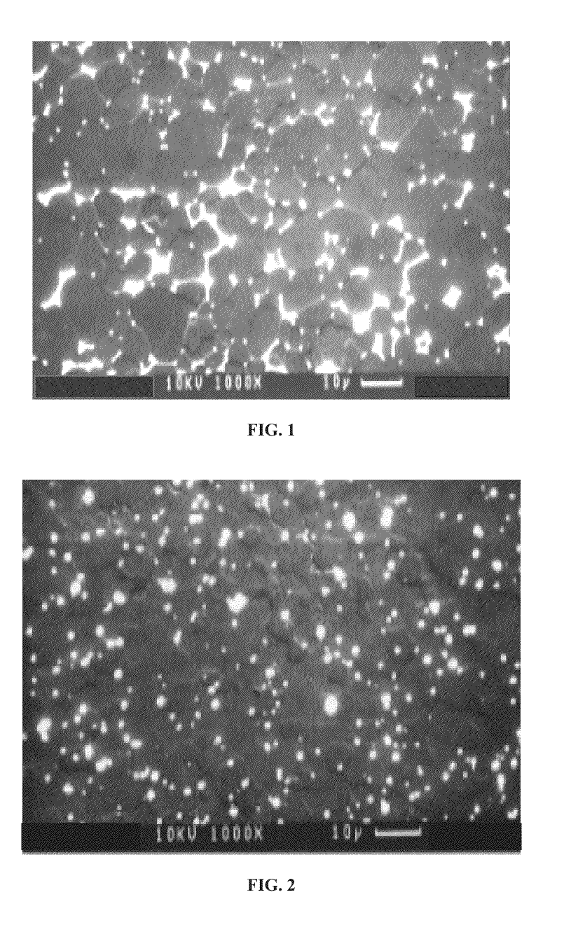

During sintering, the sintering additives (sintering aids) melt at the sintering temperature between about 1650° C. to about 1750° C. to form a liquid phase. The liquid phase wets the AlN grains, as shown in the scanning electron micrograph of FIG. 1, and promotes liquid phase sintering. The AlN particles re-arrange to increase density of the body, undergoing dissolution and re-precipitation of AlN in the sintering liquid during liquid phase sintering, which reduce pores in the body. Oxygen migrates out of the AlN grains, being gettered in the liquid phase, to increase thermal conductivity of the body. De-wetting of the sintering liquid occurs at the triple points between AlN grains to form the final de-wetted microstructure of the sintered body after sintering is completed, as shown in the scanning electron micrograph of FIG. 2.

In certain embodiments, the low temperature sintering process may be conducted in a high temperature continuous furnace, having molybdenum elements and alumina heat shields that operate up to 1750° C. The continuous sintering furnace may be a continuous belt or pusher-type furnace.

The sintering atmosphere may be nitrogen, or a combination of nitrogen and hydrogen. Hydrogen may be added to the sintering atmosphere of a metal (such as molybdenum) element-containing sintering furnace, in order to protect the metal element from oxidation. In certain embodiments, the mole ratio of hydrogen in the sintering atmosphere may be about 5 to about 15%.

In certain embodiments, sintering may be conducted at about 1710° C. for about 3 to about 5 hours. In other embodiments, sintering may be conducted at about 1690° C. for about 3 hours, with an increase to about 1710° C. for about 2 hours.

### EXAMPLES

AlN substrates were prepared from AlN powder produced by the carbothermal reduction process by tape casting a green body from the low temperature sintering formulation comprising 5 weight percent of 4 parts Yttria to 1 part Alumina and 1 part Calcia by weight as the sintering aid in one test run, and tape casting a green body from the conventional high temperature sintering formulation comprising 5 weight percent of Yttria as the sintering aid in a second test run. Weight percents are based on the amount of AlN.

The first green body was sintered according to the present tow temperature sintering process at 1700° C. for 5 hours in a hydrogen and nitrogen atmosphere, and the second green body was sintered according to the conventional high temperature sintering process at 1825° C. for 4 hours, in a hydrogen and nitrogen atmosphere. After sintering, the AlN substrate sintered at low temperature had the same microstructure and same final phases (YAlO₃, Y₄Al₂O₉) as the AlN substrate sintered according to the high temperature process. Only a trace to a small amount, if any, of calcium compound may be detected in the second phase according to the low temperature sintering process, such as a Ca—Al—Y—O compound. Most of the calcia volatilizes away during sintering.

The properties of the two sets of AlN substrates are reported in Table 1 below.

TABLE 1

| | Example 1 | Example 2 |
|---|---|---|
| | Low Temperature | High Temperature |
| Property | Process | Process |
| Thermal Conductivity | 110-130 W/m-K | 170 W/m-K |
| Flexural Strength | 300-325 MPa | 325 MPa |
| Volume Resistivity | 10¹⁴ Ohm-cm | 10¹⁴ Ohm-cm |
| Density | 98-99% | 100% |
| Appearance | Grey, translucent | Tan, translucent |

The present low temperature sintering process was conducted using AlN powder produced by the direct nitridation process. A comparison of AlN powder produced by direct nitridation, as compared to AlN powder produced by carbothermal reduction is set forth in Table 2.

TABLE 2

| | | Ex. 3 | Ex. 4 |
|---|---|---|---|
| | | Direct | Carbothermal |
| | | Nitridation | Reduction |
| Item | Units | Average | Average |
| Surface Area | m²/g | 2.61 | 2.59 |
| Mean Particle Size | μm | 1.96 | 1.13 |
| (D50) | | | |
| Mean Particle Size | μm | 11.35 | Not Reported |
| (D90) | | | |
| O | wt % | 1.16 | 0.83 |
| C | ppm | 914 | 210 |
| Fe | ppm | 96.5 | 12 |
| Si | ppm | 74 | 43 |

AlN substrates were prepared from AlN powder produced by the direct nitridation (DN) process, and separately from AlN powder produced by the carbothermal reduction (CR) process, by tape casting a green body from the low temperature sintering formulation comprising 5 weight percent of 4 parts Yttria to 1 part Alumina and 1 part Calcia by weight as the sintering aid in one set of test runs. Other AlN substrates were prepared from AlN powder produced by the direct nitridation (DN) process, and separately from AlN powder produced by the carbothermal reduction (CR) process, by tape casting a green body from the conventional high temperature sintering formulation comprising 5 weight percent Yttria as the sintering aid in a second set of test runs.

The first set of green bodies, produced from the low temperature sintering formulation and alternatively from the conventional high temperature sintering formulation, was sintered according to the present low temperature sintering process at 1675° C. for 5 hours in a nitrogen atmosphere, and the second set of green bodies produced from the two formulations was sintered according to the conventional high temperature sintering process at 1825° C. for 4 hours, in a nitrogen and hydrogen atmosphere.

Table 3 sets forth the densities after sintering of the sets of AlN substrates according to the present low temperature sintering process as compared to the standard high temperature sintering process.

TABLE 3

| | | Formula/ | | | % of |
|---|---|---|---|---|---|
| | | Firing | Sintering | Density | Theoretical |
| Ex. | Powder | Profile | Temperature | g/cm³ | Density |
| 5 | DN | Low T | 1675° C. | 3.215 (Avg of 4) | 98% |
| 6 | CR | Low T | 1675° C. | 3.292 (Avg of 2) | 99% |
| 7 | DN | High T | 1825° C. | 2.666 (Avg of 2) | 80% |
| 8 | CR | High T | 1825° C | 1316 (Avg of 2) | 100% |

The present low temperature sintering process was very effective at sintering the low cost, direct nitridation-produced AlN powder and the carbothermal reduction-produced AlN powder. The standard high temperature sintering process was ineffective at sintering the low cost direct nitridation-produced powder at typical sintering times and temperatures.

The properties of the low temperature sintered AlN substrates manufactured from direct nitridation-produced AlN powder are set forth in Table 4 below.

TABLE 4

| Property | DN AlN Results |
|---|---|
| Thermal Conductivity | 110 W/m-K |
| Flexural Strength | 300 MPa |
| Volume Resistivity | 10¹⁴ Ohm cm |
| Density | 97% dense |
| Appearance | White, translucent |

### Example 9

Pressed pellets were made from direct nitrided AlN powder, binder and 5% sintering aid of 4 parts yttria, 1 part Calcia and 1 part alumina by weight. After binder burnout at 600° C., the pellets were sintered at 1690° C. for 3 hours, and 1710° C. for an additional 2 hours. The resulting sintered AlN pellet had a density of 3.142 g/cc, a thermal conductivity of 116 W/mK, and a volume resistivity of greater than 10¹² Ohm-cm.

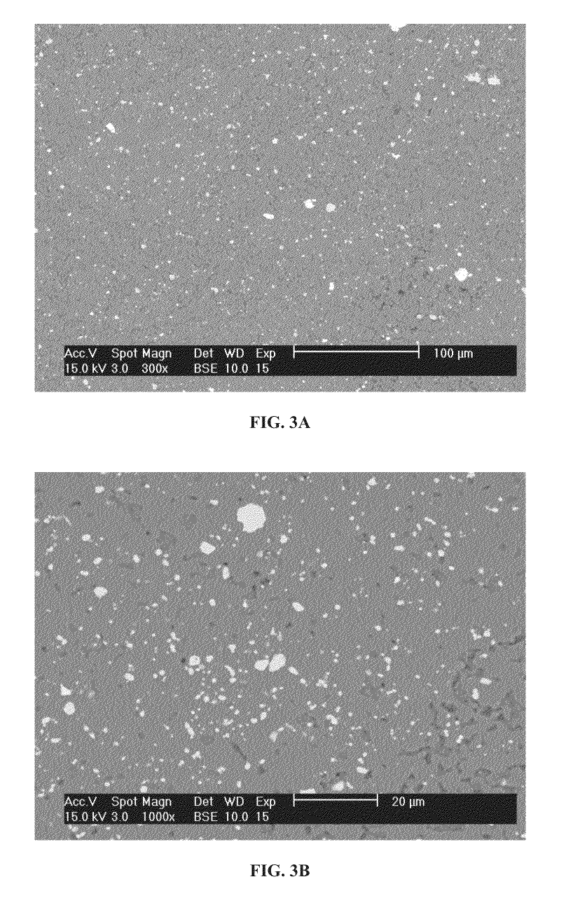

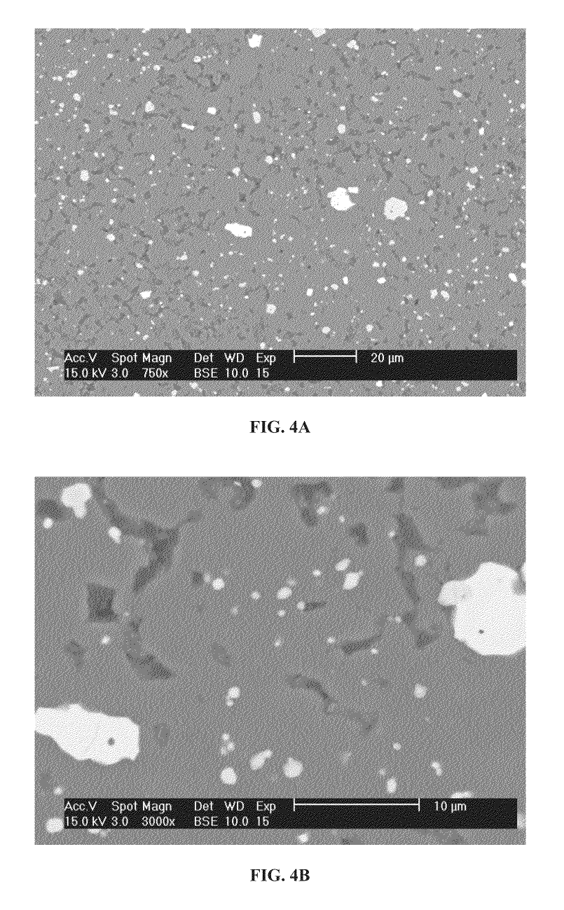

FIG. 3A, FIG. 3B, FIG. 4A and FIG. 4B are scanning electron micrographs (SEMs) of the cross-section of the microstructure of the AlN sintered pellet, at magnifications of 300×, 1000×, 750×, and 3000×, respectively. FIG. 3B is a further magnification of the center portion of the SEM of FIG. 3A, and FIG. 4B is a further magnification of the center portion of the SEM of FIG. 4A. In each of these SEMs, the white cluster regions represent de-wetted Y, Al, O second phase in the AlN ceramic.

### Example 10

Laminated cast tapes were made from direct nitrided AlN powder, binder and 5% sintering aid of 4 parts yttria, 1 part Calcia and 1 part alumina. After binder burnout at 650° C., the tapes were sintered at 1690° C. for 3 hours, and 1710° C. for an additional 2 hours. The resulting sintered AlN substrate had a density of 3.1 g/cc, a thermal conductivity of 90 W/mK.

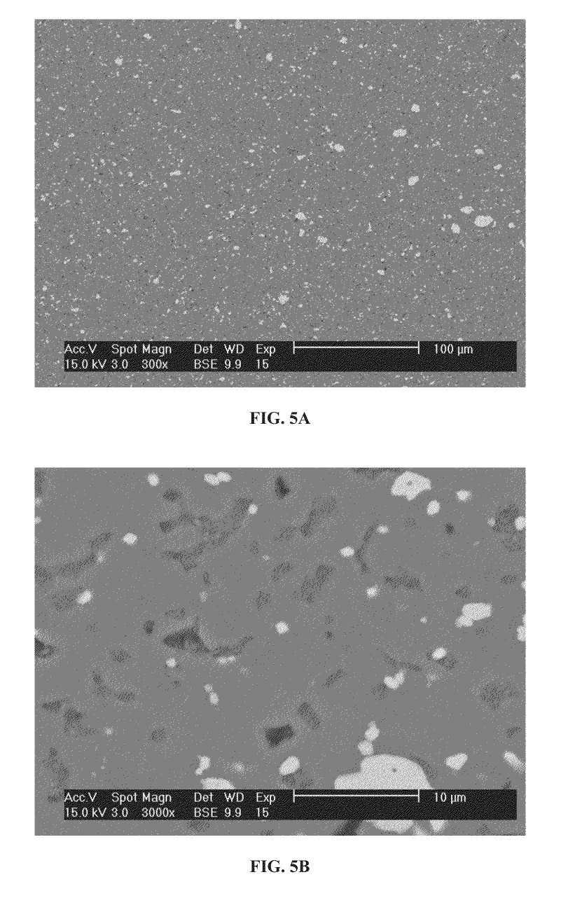

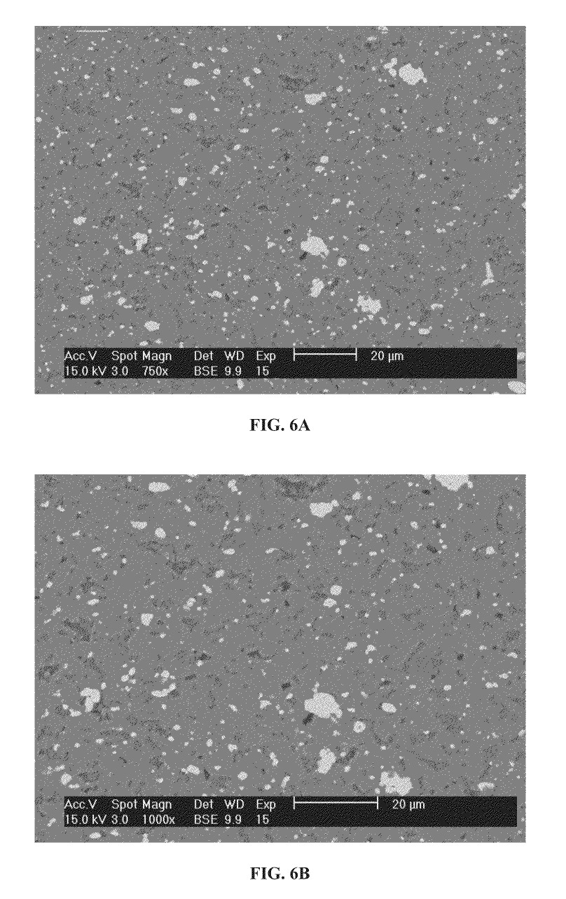

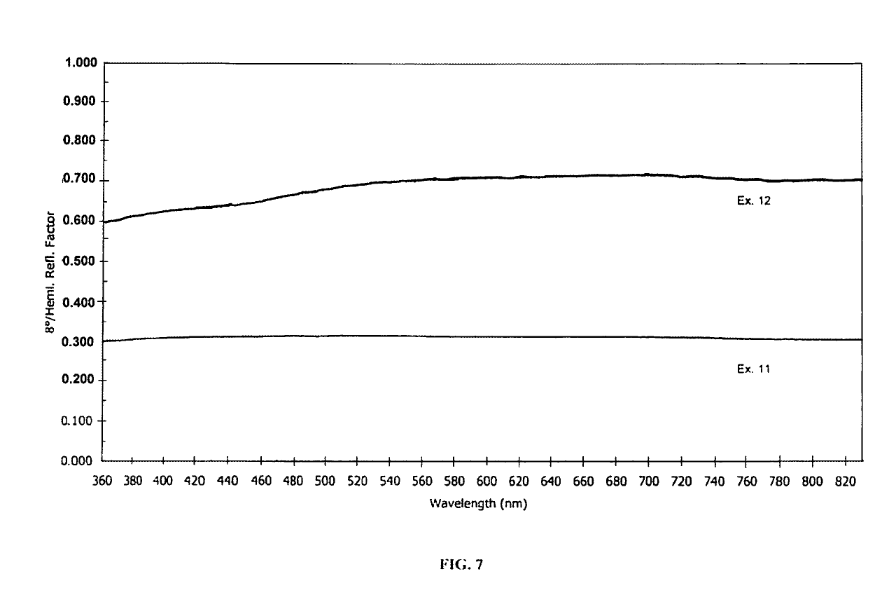

FIG. 5A, FIG. 5B, FIG. 6A and FIG. 6B are scanning electron micrographs (SEMs) of the cross-section of the microstructure of the AlN sintered substrate, at magnifications of 300×, 3000×, 750×, and 1000×, respectively. FIG. 5B is a further magnification of a portion of the SEM of FIG. 5A, and FIG. 6B is a further magnification of the center portion of the SEM of FIG. 6A. In each of these SEMs, the white cluster regions represent de-wetted Y, Al, O second phase in the AlN ceramic.

The low cost, AlN powder, formed into a green body with the present low temperature sintering aid formulation, and sintered at low temperature, exhibited the properties desired for use as HBLED substrates. The present, lower cost AlN substrates are also suitable for use in power electronic packages, automotive hybrids, and other applications where alumina is presently used.

The reflectance factor of sintered AlN substrates prepared from direct nitridation-produced AlN powder by the present low temperature sintering process was compared to the reflectance factor of sintered AlN substrates prepared from carbothermal reduction-produced AlN powder by the same low temperature sintering process. Reflectance Factor was tested according to ASTM Test Method E1331-96. The measurement instrument was a calibrated Perkin-Elmer Lambda-9/19 UV-Vis-NIR Spectrometer Ser. No. 1099, with Reflectance Accessory Ser. No. 1991.

Measurement conditions were at a mean temperature of 21° C. (Ex. 13-15) or 23° C. (Ex 11-12), and a relative humidity of 44%. Instrument parameters included a bandpass of 2 nm, a recording interval of 1.0 nm, and a scan speed of 120 nm/minute. Three measurements were averaged for each sample.

Procedure: The Total Hemispherical Reflectance measurements were performed on a Perkin-Elmer Lambda 9/19 UV-Vis-NIR Spectrophotometer. The instrument was set up in total hemispherical reflectance geometry (8°/t) using a Labsphere 150 mm integrating sphere accessory. The measurement beam was well collimated (maximum angle of convergence is ±4°). The reflectance factor measurements were relative to freshly packed PTFE (Dupont 7A) powder per ASTM Practice E259-98 and CIE 15.2 at ambient temperature (21° C. or 23° C±1°) and humidity (44±5%).

The calibration of the sample was performed at 1.0 nm. intervals over the wavelength 360-830 nm for 8°/hemispherical geometry. A tungsten-halogen source was used in combination with a photomultiplier detector. The samples were rotated about their center point and the measurements averaged. The samples were measured behind a ½″ mask, and measurements were subjected to a zero correction.

Example 11 was an AlN pressed disk 1.6 mm thick, sintered from carbothermal reduction-produced AlN powder, and had a grey visual appearance, and Example 12 was an AlN pressed disk. 1.6 mm thick, sintered from direct nitridation-produced AlN powder, and had a white visual appearance. Reflectance of the samples is reported below in Table 5.

As is shown in FIG. 7, the reflectance of the AlN disk sintered from carbothermal reduction-produced AlN powder was about 30% for the entire range of 360 nm to 820 nm wavelength light, while the reflectance of the AlN disk sintered from direct nitridation-produced AlN powder ranged from about 60% to over 70% for the entire wavelength range.

Example 13 was an AlN tape, 40 mils (1 mm) thick, tape-cast from carbothermal reduction produced AlN powder and sintered according to the conventional high temperature sintering process. The sintered AlN substrate was tan in color. Example 14 was an AlN tape, 19 mils (0.48 mm) thick, tape-cast from carbothermal reduction produced AlN powder and sintered according to the low temperature sintering process. The sintered AlN substrate was grey in color. Example 15 was an AlN tape, 21.5 rails (0.55 mm) thick, tape-cast from direct nitridation-produced AlN powder and sintered according to the subject low temperature sintering process, using a sintering aid of 4 yttria to 1 calcia and no added alumina. The sintered AlN substrate was white in color/appearance. Reflectance of the samples, tested as above, is reported below in Table 6.

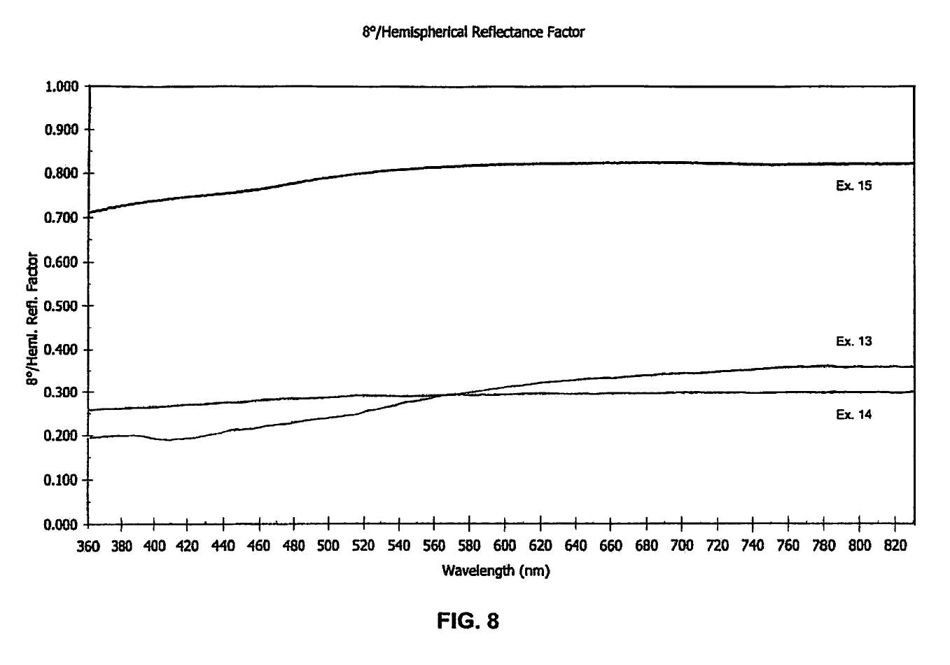

As is shown in FIG. 8, the reflectance of the AlN tapes sintered from carbothermal reduction-produced AlN powder was about 20 to 35% for the entire range of 360 nm to 830 nm wavelength light, while the reflectance of the AlN tape sintered from direct nitridation-produced AlN powder ranged from about 70% to over 80% for the entire wavelength range.

TABLE 5
8°/Hemispherical Reflectance Factor

| Wavelength | | |
|---|---|---|
| (nm) | Ex. 11 (Grey) | Ex. 12 (White) |
| 360 | 0.297 | 0.594 |
| 370 | 0.300 | 0.604 |
| 380 | 0.304 | 0.614 |
| 390 | 0.306 | 0.618 |
| 400 | 0.307 | 0.623 |
| 410 | 0.308 | 0.627 |
| 420 | 0.309 | 0.630 |
| 430 | 0.310 | 0.634 |
| 440 | 0.310 | 0.639 |
| 450 | 0.310 | 0.643 |
| 460 | 0.311 | 0.649 |
| 470 | 0.312 | 0.657 |
| 480 | 0.313 | 0.665 |
| 490 | 0.312 | 0.671 |
| 500 | 0.312 | 0.678 |
| 510 | 0.313 | 0.686 |
| 520 | 0.313 | 0.691 |
| 530 | 0.313 | 0.695 |
| 540 | 0.313 | 0.699 |
| 550 | 0.313 | 0.702 |
| 560 | 0.313 | 0.705 |
| 570 | 0.312 | 0.704 |
| 580 | 0.312 | 0.706 |
| 590 | 0.311 | 0.707 |
| 600 | 0.311 | 0.708 |
| 610 | 0.311 | 0.710 |
| 620 | 0.311 | 0.710 |
| 630 | 0.311 | 0.711 |
| 640 | 0.311 | 0.712 |
| 650 | 0.311 | 0.714 |
| 660 | 0.311 | 0.715 |
| 670 | 0.311 | 0.716 |
| 680 | 0.311 | 0.716 |
| 690 | 0.311 | 0.717 |
| 700 | 0.311 | 0.717 |
| 710 | 0.310 | 0.715 |
| 720 | 0.310 | 0.715 |
| 730 | 0.309 | 0.713 |
| 740 | 0.308 | 0.710 |
| 750 | 0.307 | 0.707 |
| 760 | 0.306 | 0.706 |
| 770 | 0.306 | 0.705 |
| 780 | 0.305 | 0.704 |
| 790 | 0.304 | 0.703 |
| 800 | 0.305 | 0.704 |
| 810 | 0.304 | 0.704 |
| 820 | 0.304 | 0.706 |
| 830 | 0.304 | 0.707 |

TABLE 6
8°/Hemispherical Reflectance Factor

| Wavelength | Ex. No. 13 - | | |
|---|---|---|---|
| (nm) | Tan | Ex. No. 14 - Grey | Ex. No. 15 - White |
| 360 | 0.197 | 0.258 | 0.710 |
| 370 | 0.196 | 0.260 | 0.718 |
| 380 | 0.198 | 0.262 | 0.726 |
| 390 | 0.198 | 0.264 | 0.732 |
| 400 | 0.192 | 0.266 | 0.737 |
| 410 | 0.189 | 0.268 | 0.741 |
| 420 | 0.192 | 0.269 | 0.745 |
| 430 | 0.198 | 0.272 | 0.749 |
| 440 | 0.205 | 0.274 | 0.752 |
| 450 | 0.211 | 0.276 | 0.756 |
| 460 | 0.217 | 0.278 | 0.762 |
| 470 | 0.223 | 0.280 | 0.768 |
| 480 | 0.229 | 0.282 | 0.775 |
| 490 | 0.234 | 0.284 | 0.782 |
| 500 | 0.239 | 0.285 | 0.788 |
| 510 | 0.244 | 0.286 | 0.794 |
| 520 | 0.251 | 0.287 | 0.798 |
| 530 | 0.261 | 0.288 | 0.803 |
| 540 | 0.270 | 0.289 | 0.807 |
| 550 | 0.279 | 0.289 | 0.809 |
| 560 | 0.286 | 0.290 | 0.812 |
| 570 | 0.292 | 0.290 | 0.813 |
| 580 | 0.298 | 0.291 | 0.815 |
| 590 | 0.304 | 0.291 | 0.817 |
| 600 | 0.310 | 0.292 | 0.818 |
| 610 | 0.315 | 0.292 | 0.819 |
| 620 | 0.319 | 0.293 | 0.820 |
| 630 | 0.323 | 0.293 | 0.819 |
| 640 | 0.326 | 0.293 | 0.820 |
| 650 | 0.329 | 0.293 | 0.821 |
| 660 | 0.331 | 0.294 | 0.821 |
| 670 | 0.334 | 0.294 | 0.821 |
| 680 | 0.336 | 0.294 | 0.822 |
| 690 | 0.339 | 0.294 | 0.822 |
| 700 | 0.341 | 0.294 | 0.822 |
| 710 | 0.343 | 0.295 | 0.821 |
| 720 | 0.346 | 0.295 | 0.820 |
| 730 | 0.348 | 0.295 | 0.819 |
| 740 | 0.350 | 0.295 | 0.819 |
| 750 | 0.352 | 0.295 | 0.817 |
| 760 | 0.354 | 0.295 | 0.819 |
| 770 | 0.355 | 0.295 | 0.819 |
| 780 | 0.355 | 0.295 | 0.819 |
| 790 | 0.356 | 0.295 | 0.820 |
| 800 | 0.356 | 0.295 | 0.820 |
| 810 | 0.357 | 0.295 | 0.820 |
| 820 | 0.356 | 0.295 | 0.819 |
| 830 | 0.357 | 0.296 | 0.820 |

### Example 16

A sintered AlN substrate was prepared from directly nitrified AlN powder, using a 5% (by weight of AlN powder) sintering aid package of 4% Y2O3, 1% CaO and 0-0.5% added Alumina with binder burnout being conducted between 650° C. and 700° C. There was some native alumina in the powder and also some alumina was formed during binder burnout. Thus, the total alumina was that added +intrinsic+reacted during binder burnout, which can be calculated based on the type of AlN powder used and the binder burnout temperature. The final second phase was de-wetted, substantially Y—Al—O containing compounds with minor or no Ca-containing phases.

The sintered AlN was white in color or appearance, was >97% dense (greater than 97% of theoretical density) and had a fully de-wetted microstructure. Thermal conductivity of the sintered AlN body was about 118 W/m-K. The white, sintered AlN, produced from the direct nitridation AlN powder, is particularly suited for HBLED applications.

### Examples 17-34

The subject low temperature sintering process was applied to both carbothermally reduced AlN and directly nitrided AlN powders. The sintering mixture formulation, the sample form, and properties of the sintered AlN material are reported in Table 7 below. All AlN samples were subjected to binder burnout at 700° C. for 1 hour, and sintering at 1690° C. for 3 hours and 1710° C. for 2 hours. All sintered AlN samples obtained from a sintering formulation comprising carbothermally reduced AlN powder were dark in color. All sintered AlN samples obtained from a sintering formulation comprising directly nitrided AlN powder were white in appearance. In Tables 7-9, Y=yttria, C=calcia, A=alumina and E=x10ⁿ.

TABLE 7
Low Temperature Sintering of AlN

| | Exam- | | | Thermal | Electrical |
|---|---|---|---|---|---|
| | ple | Sample | Density | Conductivity | Resistivity |
| Formulation | No. | Form | (g/cm³) | (W/mK) | (ohm-cm) |
| Carbothermally | 17 | Pellet | 3.315 | 115 | 2.90E+14 |
| Reduced AlN | 18 | Pellet | 3.311 | 118 | 2.44E+14 |
| with 4Y/1C/1A | 19 | Pellet | 3.313 | 124 | 9.03E+14 |
| Sintering Aid | 20 | Tape | 3.312 | 104 | 2.19E+14 |
| | 21 | Tape | 3.303 | 101 | 2.79E+14 |
| | 22 | Tape | 3.304 | 102 | 2.73E+14 |
| Directly Nitrided | 23 | Pellet | 3.234 | 95 | 4.75E+12 |
| AlN with | 24 | Pellet | 3.233 | 92 | 5.74E+12 |
| 4Y/1C/1A | 25 | Pellet | 3.234 | 94 | 7.39E+12 |
| Sintering Aid | 26 | Tape | 3.077 | 68 | 1.06E+13 |
| | 27 | Tape | 3.055 | 63 | 5.78E+12 |
| | 28 | Tape | 3.071 | 67 | 3.74E+13 |
| Directly Nitrided | 29 | Pellet | 3.212 | 119 | 4.95E+11 |
| AlN with | 30 | Pellet | 3.226 | 116 | 8.93E+12 |
| 4Y/1CaO | 31 | Pellet | 3.214 | 118 | 8.70E+12 |
| Sintering Aid | 32 | Tape | 3.284 | 92 | 7.41E+12 |
| | 33 | Tape | 3.283 | 90 | 1.22E+13 |
| | 34 | Tape | 3.277 | 90 | 1.11E+13 |

### Examples 35-39

The subject low temperature sintering process was applied to both carbothermally reduced AlN and directly nitrided AlN powders. The sintering mixture formulation, the sample form, and properties of the sintered AlN material are reported in Table 8 below. All AlN samples were subjected to binder burnout at 675° C. for 1 hour, and sintering at 1690° C. for 3 hours and 1710° C. for 2 hours. All sintered AlN samples obtained from a sintering formulation comprising carbothermally reduced AlN powder were dark in color. All sintered AlN samples obtained from a sintering formulation comprising directly nitrided AlN powder were white in appearance.

TABLE 8

| | Exam- | | | Thermal | Electrical |
|---|---|---|---|---|---|
| | ple | Sample | Density | Conductivity | Resistivity |
| Formulation | Number | Form | (g/cm³) | (W/mk) | (ohm-cm) |
| Carbothermally | 35 | Pellet | 3.287 | 146 | Not |
| Reduced ALN | | | | | Measured |
| with 4Y/1C/1A | | | | | |
| Sintering Aid | | | | | |
| Directly Nitrided | 36 | Pellet | 3.190 | 105 | 2.16E+12 |
| AlN with | 37 | Pellet | 3.187 | 100 | Not |
| 4Y/1C/1A | | | | | Measured |
| Sintering Aid | | | | | |
| Directly Nitrided | 38 | Pellet | 3.23 | 129 | 4.76E+12 |
| AlN with | 39 | Pellet | 3.232 | 130 | Not |
| 4Y/1CaO | | | | | Measured |
| Sintering Aid | | | | | |

### Examples 40-64

The subject low temperature sintering process was applied to both carbothermally reduced AlN and directly nitrided AlN powders. The sintering mixture formulation, the sample form, and properties of the sintered AlN material are reported in Table 9 below. All AlN samples were subjected to binder burnout at 650° C. for 1 hour, and sintering at 1690° C. for 3 hours and 1710° C. for 2 hours, except that Examples 46-48 were sintered for an additional 2 hours at 1675° C. Examples 49-51 were fired twice. All sintered AlN samples obtained from a sintering formulation comprising carbothermally reduced AlN powder were dark in color. All sintered AlN samples obtained from a sintering formulation comprising directly nitrided AlN powder were white in appearance.

TABLE 9

| | | | | Thermal | |
|---|---|---|---|---|---|
| | Exam- | | | Conduc- | Electrical |
| | ple | Sample | Density | tivity | Resistivity |
| Formulation | Number | Form | (g/cm³) | (W/mK) | (ohm-cm) |
| Carbothermally | 40 | Pellet | 3.292 | 154 | Not |
| Reduced AlN | | | | | Measured |
| with 4Y/1CA | 41 | Pellet | 3.291 | 151 | 7.18E+13 |
| Sintering Aid | 42 | Pellet | 3.253 | 154 | 2.46E+15 |
| | 43 | Tape | 3.234 | 154 | Conductive |
| | 44 | Tape | 3.246 | 153 | Conductive |
| | 45 | Tape | 3.261 | 154 | Conductive |
| | 46 | Tape | 3.234 | 154 | 5.54E+12 |
| | 47 | Tape | 3.246 | 153 | 4.16E+12 |
| | 48 | Tape | 3.261 | 154 | 4.61E+07 |
| Directly Nitrided | 49 | Pellet | 3.200 | 121 | 5.54E+12 |
| AlN with | 50 | Pellet | 3.210 | 121 | 4.16E+12 |
| 4Y/1CA | 51 | Pellet | 3.201 | 127 | 4.61E+07 |
| Sintering Aid | 52 | Pellet | 3.147 | 109 | 1.10E+13 |
| | 53 | Pellet | 3.135 | 106 | 1.09E+13 |
| | 54 | Pellet | 3.14 | 104 | 1.63E+13 |
| | 55 | Tape | 3.123 | 91 | 1.65E+13 |
| | 56 | Tape | 3.077 | 91 | 3.31E+13 |
| | 57 | Tape | 3.078 | 92 | 1.49E+13 |
| Directly Nitrided | 58 | Pellet | 3.232 | 128 | 3.81E+13 |
| AlN with | 59 | Pellet | 3.231 | 130 | 4.49E+13 |
| 4Y/1CaO | 60 | Pellet | 3.236 | 125 | 6.53E+13 |
| Sintering Aid | 61 | Pellet | 3.24 | 133 | 1.48E+12 |
| | 62 | Tape | 3.141 | 117 | 8.73E+10 |
| | 63 | Tape | 3.134 | 113 | 5.07E+09 |
| | 64 | Tape | 3.118 | 114 | 4.30E+08 |

We have found that white colored AlN has been produced by the subject low temperature sintering process, utilizing AlN powder produced by direct nitridation. While not wishing to be bound by theory, it is submitted that in some embodiments, the white color of the sintered AlN is at least partially due to a relatively low population of nitrogen (N) vacancies in the sintered AlN particles produced by direct nitridation of alumina.

N vacancies in the AlN lattice cause the AlN to be colored grey or tat., along with impurities such as Fe or Si. As directly nitrided (DN) AlN powder has higher Fe and Si than the carbothermally reduced (CR) powder, impurities like Fe or Si don't explain the white color or appearance. However, if the N vacancy population in the sintered AlN material is decreased, the AlN becomes whiter.

It is thought that N vacancies form during sintering, because the entropy of nitrogen in high temperature nitrogen gas is very high. This provides a thermodynamic driving force for some level of nitrogen to leave the AlN lattice and go into the gas phase. The higher the temperature, the more nitrogen will leave the AlN lattice, both because the entropy is higher and also the diffusion rate for nitrogen to move through the AlN body to get to the surface is higher at higher temperatures.

By sintering at a lower temperature in the present process as compared to conventional AlN sintering (about 1675 to 1750° C. vs. 1825° C. or greater), a lower N vacancy population can be achieved for the lower sintering temperature-produced sintered AlN material. However, we have observed that low temperature sintered AlN samples made with high purity CR powder are dark grey in color, while low temperature sintered AlN samples made with low purity DN powder are white in color or appearance and highly reflective, even when the samples have comparable density.

As discussed above, the AlN CR-derived powder has a very narrow particle size distribution. As N vacancies form by nitrogen diffusing to the surface from the bulk, the region close to the surface will have a higher N vacancy population from sintering than the bulk of the material.

If the nitrogen diffusion distance at the sintering temperature is close to the particle radius, then the whole powder particle will have N vacancies. If statistically all the powder particles are of small radius and about the same, then the whole sample will have a high population of N vacancies and will be dark in color.

The AlN DN-derived powder has a very wide particle size distribution with some very large particles. For medium to large particles, only the region near the surface will be affected by nitrogen diffusion to form N vacancies, with the bulk of the particle still having a low N vacancy population. Thus, having a wide particle size distribution in the AlN powder to be sintered would result in much of the bulk of the DN-derived AlN grains having a low N vacancy population and thus having a white color or appearance. Without being bound by theory, we submit that the sintering of the DN-derived AlN grains having a low native N vacancy population according to the present low temperature sintering process minimizes the formation of new N vacancies and results in the sintered AlN product having a white appearance and a reflectance factor of at least about 60% in the visible wavelength range.

In contrast, sintering AlN material in argon, which increases the N vacancy population, makes the sintered AlN material darker than those AlN samples sintered in nitrogen, and further decreases the reflectance factor.

The reflective (white-appearing) AlN substrates sintered from direct nitridation-produced AlN powder are particularly suited for HBLED applications.

There is thus provided a sintered aluminum nitride substrate having a thermal conductivity of about 60 W/m-K to about 150 W/m-K, a flexural strength of about 200 MPa to about 325 MPa, a volume resistivity of greater than 10¹⁰ Ohm cm, a density of at least about 95% of theoretical, optionally at least 97%, and a reflectance factor of at least about 60% substantially over the wavelength range of 360 nm to 820 nm when tested according to ASTM Test Method E1331-96 for a sample from 0.55 to 1.6 mm thick in a total hemispherical reflectance geometry of 8°/t. The thickness of the sample refers to the test methodology discussed above, and is not a limitation on the thickness of sintered AlN substrates that can be prepared by the subject low temperature sintering process. The appropriate thicknesses of AlN substrates can be determined by the particular application in which they are to be used.

The low temperature process for sintering aluminum nitride comprises providing an AlN sintering formulation comprising AlN powder and a sintering aid consisting essentially of yttria, calcia, and optionally added alumina, forming the AlN sintering formulation into a green body, and sintering the green body at a temperature of about 1675° C. to 1750° C. to form a sintered AlN body having a substantially dewetted second phase consisting essentially of yttria and alumina containing compounds.

Also provided is a sintered AlN body prepared by sintering a formulation of AlN powder produced by the direct nitridation of aluminum metal, hinder and a sintering aid consisting of yttria, calcia and optionally added alumina, wherein after binder burnout and sintering, the sintered AlN body has a second phase consisting essentially of yttrium and aluminum compounds that is substantially de-wetted from AlN grains.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A sintered aluminum nitride substrate having a thermal conductivity of about 60 W/m-K to about 150 W/m-K, a flexural strength of about 200 MPa to about 325 MPa, a volume resistivity of greater than 10¹⁰ Ohm cm, a density of at least about 95% of theoretical, optionally at least 97%, and a reflectance factor of at least about 60% substantially over the wavelength range of 360 nm to 820 nm when tested according to ASTM Test Method E1331-96 for a sample from 0.55 to 1.6 mm thick in a total hemispherical reflectance geometry of 8°/t.

2. The sintered aluminum nitride substrate according to claim 1 exhibiting a reflectance factor in the range of 60% to over 70%, optionally 60% to at least 71%, further optionally 60% to about 82%, for the sample from 0.55 to 1.6 mm thick, over the wavelength range of visible light (380 nm to 780 nm).

3. The sintered aluminum nitride substrate according to claim 1 having a white appearance.

4. The sintered aluminum nitride substrate according to claim 1 wherein the substrate exhibits a thermal conductivity of greater than 105 W/m-K.

5. The sintered aluminum nitride substrate according to claim 1 wherein the substrate exhibits a flexural strength of about 250 MPa to about 325 MPa.

6. The sintered aluminum nitride substrate according to claim 1 wherein the substrate exhibits a volume resistivity of 10¹² to about 10¹⁴.

7. The sintered aluminum nitride substrate according to claim 1 prepared by sintering a formulation of AlN powder produced by the direct nitridation of aluminum metal, binder and a sintering aid consisting essentially of yttria, calcia and optionally added alumina, wherein after binder burnout and sintering, the sintered aluminum nitride substrate has a second phase consisting essentially of yttrium and aluminum compounds that is substantially de-wetted from AlN grains.

8. The sintered aluminum nitride substrate according to claim 7 wherein said sintering is carried out below 1750° C.

9. The sintered aluminum nitride substrate of claim 7 wherein the sintering aid is present in the formulation in an amount of about 3% to about 10% by weight of AlN.

10. A low temperature process for sintering aluminum nitride comprising providing an AlN sintering formulation comprising AlN powder and a sintering aid consisting essentially of yttria, calcia, and optionally added alumina, forming the AlN sintering formulation into a green body, and sintering the green body at a temperature of about 1675° C. to 1750° C. to form a sintered AlN body having a substantially dewetted second phase consisting essentially of yttria and alumina containing compounds.

11. The low temperature sintering process of claim 10, wherein the AlN sintering formulation additionally comprises an organic binder and optionally a dispersant, plasticizer and/or solvent, further comprising burning out the binder and if present, the dispersant, plasticizer and/or solvent, in air.

12. The low temperature sintering process of claim 10, wherein forming the green body comprises casting a tape.

13. The low temperature sintering process of claim 12, wherein tape cast sheets are laminated together to a density prior to burning out the binder.

14. The low temperature sintering process of claim 10, wherein the AlN powder is the product of direct nitridation of aluminum metal.

15. The low temperature sintering process of claim 10, wherein the sintered aluminum nitride substrate has a thermal conductivity of about 60 W/m-K to about 150 W/m-K, a flexural strength of about 200 MPa to about 325 MPa, a volume resistivity of greater than 10¹⁰ Ohm cm, a density of at least about 95% of theoretical, optionally at least 97%, and a reflectance factor of at least about 60% substantially over the wavelength range of 360 nm to 820 nm when tested according to ASTM Test Method E1331-96 for a sample from 0.55 to 1.6 mm thick in a total hemispherical reflectance geometry of 8°/t.

16. A sintered AlN body prepared by sintering a formulation of AlN powder produced by the direct nitridation of aluminum metal, binder and a sintering aid consisting of yttria, calcia and optionally added alumina, wherein after binder burnout and sintering, the sintered AlN body has a second phase consisting essentially of yttrium and aluminum compounds that is substantially de-wetted from AlN grains.

17. The sintered AlN body of claim 16, having a reflectance factor in the range of 60% to greater than 70%, optionally 60% to about 82%, over the wavelength range of visible light 380 nm to 780 nm when tested according to ASTM Test Method E1331-96 for a sample from 0.55 to 1.6 mm thick in a total hemispherical reflectance geometry of 8°/t.

18. The sintered AlN body of claim 16, having a thermal conductivity of about 60 W/m-K to about 150 W/m-K, a flexural strength of about 200 MPa to about 325 MPa, a volume resistivity of greater than 10¹⁰ Ohm cm, and a density of at least about 95% of theoretical, optionally at least 97%.
